(19) United States
(12) Patent Application Publication
(10) Pub. No.: US 2023/0198217 A1
(43) Pub. Date: Jun. 22, 2023

(54) SCALABLE OPTICALLY PUMPED CO2 WITH HOLMIUM -DOPED PUMP SOURCE

(71) Applicant: BAE SYSTEMS Information and Electronic Systems Integration Inc., Nashua, NH (US)

(72) Inventors: Gregory T. HOHENSEE, Nashua, NH (US); Peter A. BUDNI, Nashua, NH (US); Robert N. CAMPBELL, Corrales, NM (US); John S. LOVELL, Corrales, NM (US)

(73) Assignee: BAE SYSTEMS Information and Electronic Systems Integration Inc., Nashua, NH (US)

(21) Appl. No.: 17/644,591

(22) Filed: Dec. 16, 2021

(51) Int. Cl. H01S 3/223; H01S 3/067; H01S 3/11; H01S 3/094; H01S 3/16; H01S 3/13

(52) U.S. Cl. CPC H01S 3/2232; H01S 3/06716; H01S 3/11; H01S 3/094042; H01S 3/161; H01S 3/1653; H01S 3/1616; H01S 3/13

(57) ABSTRACT

The system and method for a scalable optically pumped CO₂ laser. The optically pumped CO₂ laser having a Tm fiber laser configured to pump a Q-switched Ho laser that is configured to pump a molecular isotopologue mix of CO₂ above atmospheric pressure, to produce a broadband, high energy, tunable output beam.

### STATEMENT OF GOVERNMENT INTEREST

This invention was made with United States Government support under Contract No. N0001419C1048 awarded by the U.S. Navy. The United States Government has certain rights in this invention.

### FIELD OF THE DISCLOSURE

The present disclosure relates to infra-red, optically pumped carbon dioxide (CO₂) lasers and more particularly to one pumped by a Holmium (Ho)-based pump laser.

### BACKGROUND OF THE DISCLOSURE

Optically pumped CO₂ has been partially explored as a lower SWaP-C alternative to electrically pumped CO₂ for long-wave infrared (LWIR) sources. Electrically pumped CO₂ has size, efficiency, complexity, and maintenance challenges that are negated in optical pumping, but the power scaling for optically pumped CO₂ is limited by the source power of the mid-wave infrared (MWIR) pump. Optically pumped molecular lasers (OPML) in general stand or fall on their front end, which is a MWIR pump source. That is, no system can outperform its primary energy source. Robustness is another important feature of these systems. Typical OPML systems function at low pressure, e.g., sub atmospheric pressure. Consequently, these systems have constraints on required bandwidth, and on locking onto a narrow bandwidth gas pump transition of hundreds of MHz full width at half maximum.

CO₂ OPML function, at raised pressure, has been demonstrated before, and is an arena of current research. The standard approach has been to access the fundamental 4 μm transition (000)→(001). This approach, possesses several less than favorable features including a propensity for nonlinear effects, given the strength of the transition. With prior methods there is also a necessity to detune spectrally or significantly dilute the active gas mix if any reasonable pump scale depth is desired. If detuning is selected, then such path, subject to any implementation of molecular isotopologues in a gas mix, conveys a constraint on a diode-pumped solid-state (DPSS) front end choice—specifically the front end has to be tunable and efficient into a viable spectral region. If on the other hand, dilution is selected, the gas has to be driven to significant saturation levels if any worthwhile small signal gain is to be induced. As a consequence, high vibrational temperatures are driven, molecular dissociation rates increase, and arbitrary molecular isotopologue gas mixes cannot be sustained.

In order to create a viable OPML solution capable of attaining the objectives of efficiency, robustness, reliability, limited footprint and enabling the use of arbitrary molecular isotopologue mixes, and thus real sustainable gain distribution engineering, a systemic view needs to be applied.

Wherefore it is an object of the present disclosure to overcome the above-mentioned shortcomings and drawbacks associated with the conventionally pumped CO₂ systems.

### SUMMARY OF THE DISCLOSURE

The present disclosure describes a solution using a Holmium (Ho)-based pump laser and alternate CO₂ isotopes to provide a superior scaling path versus prior alternatives. The CO₂ optically pumped wavelengths identified in this application correspond to a class of lasers presenting with near ideal diode laser pumping characteristics, and high efficiency theoretical limits. These wavelengths can access two CO₂ optical pump paths—one direct, and the other indirect. The latter presenting precisely with the limiting quantum energy efficiency of the (000)→(001) transition.

One aspect of the present disclosure is an optically pumped CO₂ laser, comprising: a Tm fiber laser configured to pump a Q-switched Ho laser at about 1.9 μm; the Q-switched Ho laser being configured to pump a molecular isotopologue mix of CO₂ above atmospheric pressure at about 2 μm, to produce a tunable output beam at about 8-12 μm.

One embodiment of the optically pumped CO₂ laser is wherein the tunable output beam has a sub picosecond to 10s of nanosecond pulsed regime capability.

Another embodiment of the optically pumped CO₂ laser is wherein the tunable output beam is pulsed mJ to J class or greater.

Yet another embodiment of the optically pumped CO₂ laser is wherein the molecular isotopologue mix of CO₂ is at an atmospheric pressure of about 5 atm.

In certain embodiments, the molecular isotopologue mix of CO₂ is arbitrary in both proportion and species. In some cases, the molecular isotopologue mix of CO₂ comprises symmetric molecular isotopologues as component species of an active gas mix. In some embodiments, the molecular isotopologue mix of CO₂ comprises symmetric and asymmetric molecular isotopologues as component species of an active gas mix.

Yet another embodiment of the optically pumped CO₂ laser is wherein the Tm fiber laser is at 1940 nm and pumps the Q-switched Ho laser for pulse durations in a range of about 2 ms to about 15 ms.

Yet still another embodiment of the optically pumped CO₂ laser is wherein the Tm fiber laser pumps the Q-switched Ho laser via continuous wave.

In certain embodiments, the Ho laser is in a spectral range of about 2.05 to about 2.1 μm.

Another aspect of the present disclosure is an optically pumped CO₂ laser, comprising: a Tm fiber laser at 1940 nm configured to pump a Q-switched Ho laser at about 1.9 μm; the Q-switched Ho laser being configured to pump a molecular isotopologue mix of CO₂ at an atmospheric pressure ranging from about 2.5 atm to about 10 atm at about 2 μm, to produce a tunable output beam at about 8-12 μm.

One embodiment of the optically pumped CO₂ laser is wherein the tunable output beam has a sub picosecond to 10s of nanosecond pulsed regime capability.

Another embodiment of the optically pumped CO₂ laser is wherein the tunable output beam is pulsed at mJ to J class or greater.

Yet another embodiment of the optically pumped CO₂ laser is wherein the molecular isotopologue mix of CO₂ comprises symmetric molecular isotopologues as component species of an active gas mix.

Yet another aspect of the present disclosure is a method for optically pumping a CO₂ laser, comprising: pumping a Q-switched Ho laser at about 1.9 μm via a Tm fiber laser at 1940 nm; pumping a molecular isotopologue mix of CO₂ at above atmospheric pressure via the Q-switched Ho laser at about 2 μm; and forming a tunable output beam at about 8-12 μm.

One embodiment of the method for optically pumping a CO₂ laser is wherein the tunable output beam is pulsed at mJ to J class or greater.

Another embodiment of the method for optically pumping a CO₂ laser is wherein the molecular isotopologue mix of CO₂ is arbitrary in both proportion and species.

Yet another embodiment of the method for optically pumping a CO₂ laser is wherein an operating atmospheric pressure ranges from about 2.5 atm to about 10 atm.

Still yet another embodiment of the method for optically pumping a CO₂ laser is wherein the tunable output beam has a sub picosecond to 10s of nanosecond pulsed regime capability.

In certain embodiments, the molecular isotopologue mix of CO₂ comprises symmetric molecular isotopologues as component species of an active gas mix.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure. The patent or application file contains at least one drawing executed in color. Copies of this patent or patent application publication with color drawing(s) will be provided by the Office upon request and payment of the necessary fee.

FIG. 1A is an energy level diagram for CO₂ when pumped with a 2 μm Holmium (Ho) laser according to the principles of the present disclosure.

FIG. 1B is a diagram showing CO₂ isotope notation.

FIG. 1C is a diagram of an emission spectrum for one embodiment of the scalable optically pumped CO₂ laser over the range of about 9 μm to about 11.5 μm according to the principles of the present disclosure.

FIG. 2A is a diagram of one embodiment of a scalable optically pumped CO₂ laser with a Holmium-doped pump source.

FIG. 2B shows system pulse sequencing from one embodiment of a scalable optically pumped CO₂ laser with a Holmium-doped pump source according to the principles of the present disclosure.

FIG. 3 shows CO₂ isotope absorption versus 2 μm emission according to the principles of the present disclosure.

FIG. 4 is a plot of energy per pulse versus diode current for one embodiment of a scalable optically pumped CO₂ laser with a Holmium-doped pump source according to the principles of the present disclosure.

FIG. 5 is a plot of energy per pulse versus diode current for another embodiment of a scalable optically pumped CO₂ laser with a Holmium-doped pump source according to the principles of the present disclosure.

FIG. 6 is a flow chart of one embodiment of a method for optically pumping a CO₂ laser according to the principles of the present disclosure.

### DETAILED DESCRIPTION OF THE DISCLOSURE

A need exists to produce compact long wave infrared (LWIR) devices capable of energy scaling, near diffraction limited output, and waveform flexibility. Current technologies are cumbersome due to difficult scaling paths. For example, electrically excited CO₂ lasers or optical parametric oscillators or amplifiers (OPO/OPA) utilizing the non-linear optical processes to create a tunable wavelength output from a short pulsed infrared laser. Existing technology offerings with raised pressure operation are also discharge pumped. The scalability of discharge pumped systems is seriously hindered by the voltage requirement commensurate with such scaling attempts. In some existing systems, poor wall-plug efficiency is a challenge, as for example found in the PaR Systems, LLC HP 300/75, which for near Gaussian beam quality resides in the vicinity of ˜0.1 to perhaps 0.3% of net input power.

One embodiment of the present disclosure provides several solutions to problems with conventional systems. In contrast to discharge pumping of prior systems, optical pumping enables efficient CO₂ OPML function at raised pressure. As used herein, pressure could be in the range of about 2.5 atm to about 10 atm and can be varied to optimize for the application. In certain embodiments of the present disclosure, this approach is readily scalable as well.

Optical pumping as described herein, appropriately executed, does not result in excessive molecular dissociation, nor necessitate a catalyzer for recombination purposes. Traditionally, molecular dissociation plus recombination immediately excludes the use of arbitrary molecular isotopologue mixes through statistical mixing. For example, specifically for CO₂, iron is a very low activation energy material for dissociative adsorption. That is, it is effectively an inhomogeneous phase catalyst. So, when recombination happens in such a case, the recombination is not confined to the molecular or atomic components that made up the first dissociation. Similarly, the gas must be dry, of very low H₂O content, as H₂O presence may result in H₂CO₃ formation and dissociation, providing a homogenous phase mixing path. In contrast, one embodiment of the present disclosure employs an arbitrary molecular isotopologue mix, in both species and proportion, to access the full capability of CO₂ as a laser medium. This opens a path to unprecedented engineering of the available spectrally dependent gain distribution, and continuous tunability of CO₂ as a laser medium allowing for access to the sub picosecond pulsed regime from a CO₂ laser.

Regarding the bandwidth of the system, the CO₂ optically pumped gas is at raised pressure (i.e., notably above atmospheric pressure). Consequently, for CO₂, the individual CO₂ ro-vibrational pump transitions, or transitions involving changes in both vibrational and rotational states, pressure broaden and coalesce into a broad pump band which is easily and robustly accessible to the MWIR pump laser source.

Regarding the MWIR pump source, there is a family of diode-pumped solid-state (DPSS) lasers, which lase near naturally on identified pump transitions of CO₂. Additionally, these laser sources are behaviorally near ideally configured for diode laser pumping, courtesy of the extended, millisecond regime excited level lifetimes thereof. These specific media have demonstrated useful energy extraction and efficiency characteristics rendering them candidates for the MWIR front end pump of the CO₂ OPML described herein.

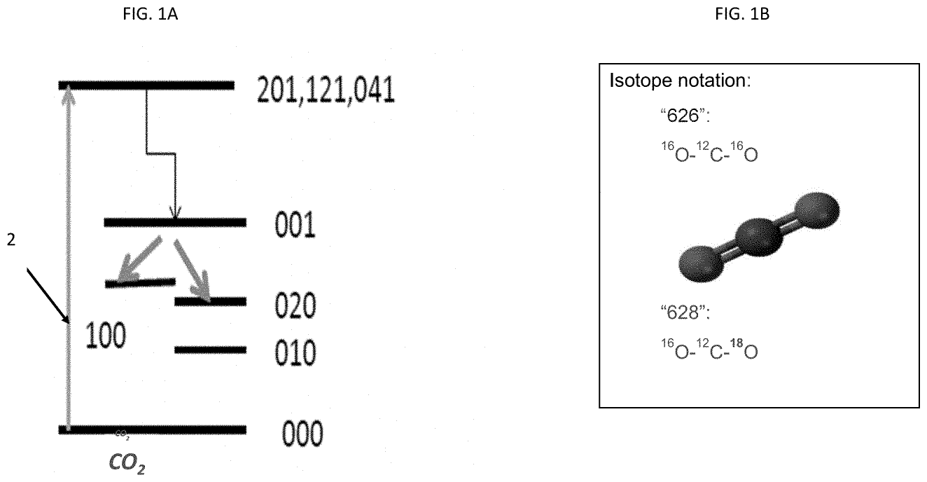

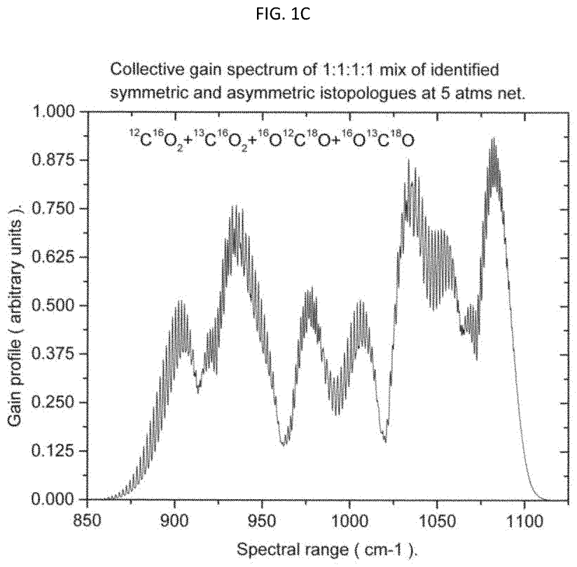

The present disclosure extends existing high energy 2 μm short wave infrared (SWIR) solid-state laser sources to the 8-12 μm LWIR spectral region via approximately 2 μm optically pumped CO₂ laser transitions. In one embodiment of the scalable, optically pumped CO₂ system of the present disclosure, a Ho-doped laser source emits in the 2 μm region, slightly offset from a natural CO₂ absorption band suitable for excitation to cause emission in the 9-11 μm region (See, FIG. 1C). However, three less-abundant isotopes of CO₂ (versus the natural ¹⁶C—¹²O—¹⁶C aka “626”) have good spectral overlap with Ho-doped pump sources. By combining high-energy Holmium pump lasers and optically pumped CO₂, the known LWIR power scaling problem is solved.

Ho-doped systems have spectral characteristics that favor remarkably high energy, Joule class and greater, operation. Ho sources can emit over a range of wavelengths within the approximately 2.05 μm to approximately 2.1 μm spectral band encompassing multiple CO₂ isotopes, which can be mixed for a broadband, approximately 8.8 μm to in excess of approximately 11.5 μm emitting, CO₂ laser system, with correspondingly ultrashort (theoretically ˜0.5 ps and up) LWIR laser pulse capability. In certain embodiments, the net result is a uniquely compact, stable, scalable high energy-per-pulse LWIR source for sensing and countermeasures that is of comparable or lesser complexity to existing approaches that use approximately 4 μm pump laser systems to target stronger CO₂ absorption features but have limited pump power output.

Referring to FIG. TA, an energy level diagram for CO₂ when pumped with a 2 μm Holmium (Ho) laser according to the principles of the present disclosure is shown. More specifically, for high partial pressure CO₂ mixes, which are possible for the specific transitions presented/of interest, 2 μm radiation optically pumps CO₂ (OP-CO₂) without resorting to pump detuning off band center. This permits a useful pump scale length, and facilitates clearing of the 100/020 levels by near resonant V-V collisional exchange with other CO₂ molecules. Time constants are approximate, at about 2 ns-atm for 100 to 020. For (100+020) to 010, the time constant is approximately 10 ns-atm.

In one embodiment of the OP-CO₂ approach of the present disclosure, the about 10 μm (e.g., 8-12 μm) emission has a limiting efficiency of about 20%. In certain embodiments, the CO₂ partial pressure function is important (e.g., ˜5 atm). This behavior enhances pulsed operation via suppression of population choke. The raised pressure function also admits relaxed spectral control for the 2 μm pump laser.

In traditional raised pressure cases, the system suppresses rotational hole burning, thus maximizing efficiency. At raised pressure, entering the ultra-short pulse domain makes attainment of rotational hole burning behavior possible, but that is unlikely as pulse duration is reduced, bandwidth spreads, and a transition to a direct lasing field interaction with the rotational distribution as a whole occurs. Rotational hole burning requires pulses shorter than the rotational relaxation time, which is near gas kinetic, which at 5 atm is about 50 to 100 ps.

For a conventional discharge pumped high pressure CO₂ system, at about 10 atm, with an approximately 1:1:25 CO₂:N₂:He mix, the time constant is about 30 ns for (100+020) to 010 relaxation, and about 5 ns for 100 to 020 relaxation. This is superior to existing Transversely Excited Atmospheric (TEA) CO₂ systems with a standard 1:1:10 mix, wherein the respective time constants are 25 ns and 120 ns, respectively. In one embodiment of the present disclosure, a 5 atm pure OP-CO₂ approach has time constants of about 0.4 ns and 2 ns, respectively.

Referring to FIG. 1B, a diagram showing CO₂ isotope notation according to the principles of the present disclosure is shown. More specifically, it is understood that carbon has several stable isotopes (e.g., ¹²C, ¹³C, and ¹⁴C) and oxygen has several stable isotopes (e.g., ¹⁶O, ¹⁷O, and ¹⁸O). These oxygen isotopes are available in water or gas form, courtesy of the demands of medical use, for Nuclear Magnetic Resonance (NMR). Thus, CO₂ is attainable in essentially all of the isotopic combinations of interest here. The CO₂ molecule is represented by ¹⁶O—¹²C—¹⁶O (aka “626”) as it is a linear molecule and thus depending on the isotopes of carbon and oxygen present in the CO₂ molecule the numerical notation of the isotope could be 626, 636, 628, 828, or the like. Additionally, asymmetric molecular isotopologues of CO₂ such as 628, 638, 728 or similar possess twice the spectral density of ro-vibrational transitions than presented by the symmetric molecular isotopologues (626, 636, 828 and the like). As a consequence, the operational pressure required to engineer useful continuous tunability or low or ripple free gain distributions is effectively halved. The ability to sustainably mix molecular isotopologues in arbitrary proportions to form an engineered gain medium further potentiates this utility given the relative isotopic shifts between available molecular isotopologues.

Referring to FIG. 1C, a diagram of an emission spectrum for one embodiment of the scalable optically pumped CO₂ laser over the range of about 9 μm to about 11.5 μm according to the principles of the present disclosure is shown. More specifically, this is an illustration of one embodiment and elucidates that one is not restricted to this one embodiment, as numerous CO₂ species are available, proportions of various CO₂ species are selectable, and pressure can and should be modified to serve different applications, i.e., one has tools to further engineer gain distribution as desired in different embodiments of this technology.

As used herein, species are any stable molecular isotopologues that suit the needs of engineering for a desired gain profile. For example, one can leverage any of 626, 636, 727, 737, 828, 838, 627, 628, 637, 638, 728,738, 646, 747, 848, 647, 748 or the like. For proportions, this means how the mix is made up. For example, say there are three species, this could be 1:1:1 (i.e., ⅓ of total mix is made up of each species in turn). It is also possible that one will optimize more complexly with say 1:2:1, 3:1:5, or the like.

In certain embodiments, the system has application in commercial material processing applications as present-day high power/energy CO₂ lasers are expensive and bulky. As an example of the latter, the PaR Systems LLC HP 300/75 weighs in at 2 metric tons for about a 30 W average output in TEMₒₒ, or 15 mW/kg. For a reasonable beam quality then, it is worth volumetrically about 10 W/m³. To re-emphasize, the Watts in the preceding example are average power. The present system is approximately three orders of magnitude smaller than was possible via previous approaches. Because of the high voltage required for previous systems they are filled with high dielectric strength oil, sheets of dielectric plastic, and contained in a steel tank. The present approach also has a reduction in net power consumption. Consequently, thermal management and power supply peripherals are proportionally smaller. The DPSS front end of the OP-CO₂ system, is in principle compact (high volumetric energy extraction, low voltage diode laser drivers), and the extraction from the optically pumped high pressure high partial pressure gas is in the range of an order to two orders of magnitude greater than possible in the PaR systems gas element.

The OP-CO₂ approach of the present disclosure has the promise to greatly reduce complexity and enhance system robustness and reliability. For example, there is no high voltage switching, no high voltage pulse forming network, no attributable EM pulses or EM interference, no discharge related gas degradation, and no failure of optics in beamline courtesy of discharge byproducts depositing on optics forming nascent ablation sites. Additionally, the advent of high harmonic generation to the X-RAY region with high peak power wavelengths has promise for tabletop cancer treatment and material investigation (molecular and larger). In certain embodiments, the Ho pumped approach, if used with a mixture of CO₂ isotopologues, creates large broad emission gain bandwidths (i.e., multiple microns) which are highly amenable for ultrashort high peak power emission for the high harmonic generation scheme. Ultrashort as used herein denotes picosecond to 100's of femtoseconds.

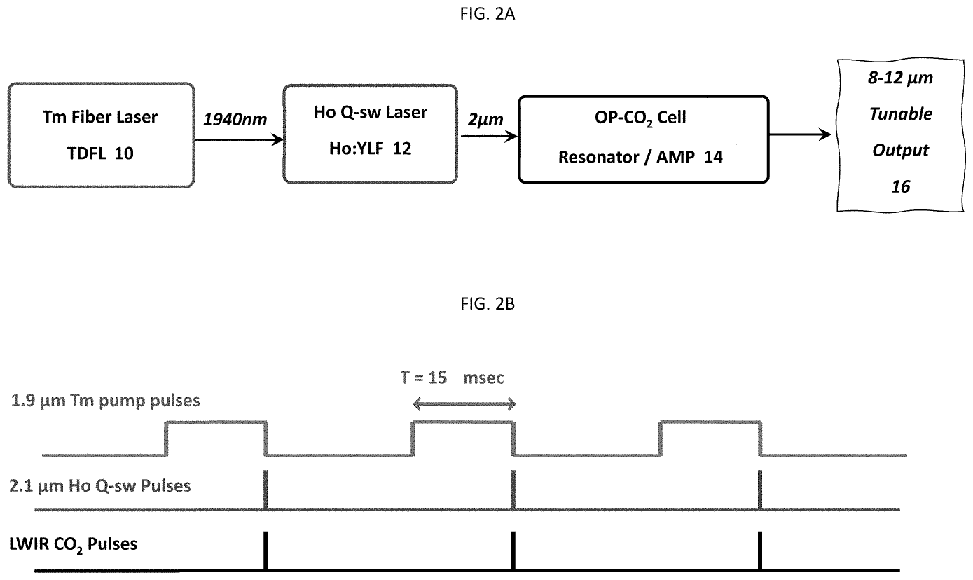

Referring to FIG. 2A, a diagram of one embodiment of a scalable optically pumped CO₂ laser with a Holmium-doped pump source is shown. More specifically, one or more 2 μm solid-state lasers optically pump CO₂ (OP-CO₂). In some embodiments, the 2 μm emission is aligned for optimal absorption of pressurized CO₂ gain elements. In certain embodiments, the OP-CO₂ gain cells 14 are configured as oscillator and or amplifier(s) for scaling. In one embodiment, mature laser diodes pump thulium (Tm) fiber lasers 10, which in turn pump solid-state 2 μm Holmium (Ho) lasers 12, for high energy emission 16. In one embodiment, the Tm laser is at about 1940 nm. In one embodiment, the 2 μm Ho laser is configured as an energy storage pulse pumped, Q-switched device, having a high pulsed energy output, low pulse repetition frequency (PRF); or burst or repetition rated capability, with an architecture capable of high PRF in the continuous wave (CW) pumped repetitively Q-switched mode. In certain embodiments, the output of the system 16 is at about 8-12 μm and high energy. Depending on scaling, the system output ranges from sub-joule to conceivably kilojoule and beyond as there is no engineering impediment, but rather a cost impediment to more powerful systems. In certain embodiments, the system output is continuously tunable. Scaling can be accomplished via scaling up a unitary Ho front end as a pump, or by parallel multiplexing multiple smaller units to yield a net pump energy increase. Mutual coherence is not required, only that the multiple pumps are introduced in the medium temporally commonly synced.

Referring to FIG. 2B, system pulse sequencing from one embodiment of a scalable optically pumped CO₂ laser with a Holmium-doped pump source according to the principles of the present disclosure are shown. More specifically, the first laser in this embodiment is a Tm laser at about 1.9 μm and this laser pumps a Q-switched Ho laser at about 2.1 μm to optically pump the CO₂ gain medium to produce about an 8-12 μm, high energy, tunable output beam. As can be seen in the embodiment, the timing (pulse duration) of the pulses are, for the Tm laser, about 15 ms, and, for the Ho laser and the CO₂ laser, much shorter where the resulting CO₂ output pulses are within, spectrally, the LWIR region of the infrared spectrum. Conventionally the LWIR spectral region resides in the range of approximately 8 μm to approximately 15 μm, otherwise considered the thermal imaging region. In certain embodiments, the output pulse is in the mJ to greater than 100s of mJ per pulse, and the pulse length is in the 10s of ns range. Again, it should be emphasized, there is no apparent engineering impediment to scaling of this technology to pulsed outputs approaching a kJ and beyond.

TABLE 1
Data for optional compact, high energy burst infrared lasers

| 2 μm | CO₂ | Features of | Features of |
|---|---|---|---|
| pump laser | isotopologues | CO₂ | 2 μm pump lasers |
| Tm:YAG | 626, 636 | 626 abundant | Direct Diode Pump |
| | | 636 low cost | Low emission cross |
| | | | section |
| | | | Path to energy scaling |
| Ho:YLF | 636, 828, 628 | 636 low cost | 1940 nm Tm Fiber |
| | | 828 high cost | Laser Pumped |
| | | 628 rare - | Large cross section |
| | | greater than | Path to energy scaling |
| | | high cost. | |
| Ho:YAG | 628 | 628 rare - | 1907 nm Tm Fiber |
| | | greater than | Laser Pumped |
| | | high cost. | Large cross section |
| | | | Path to energy scaling |

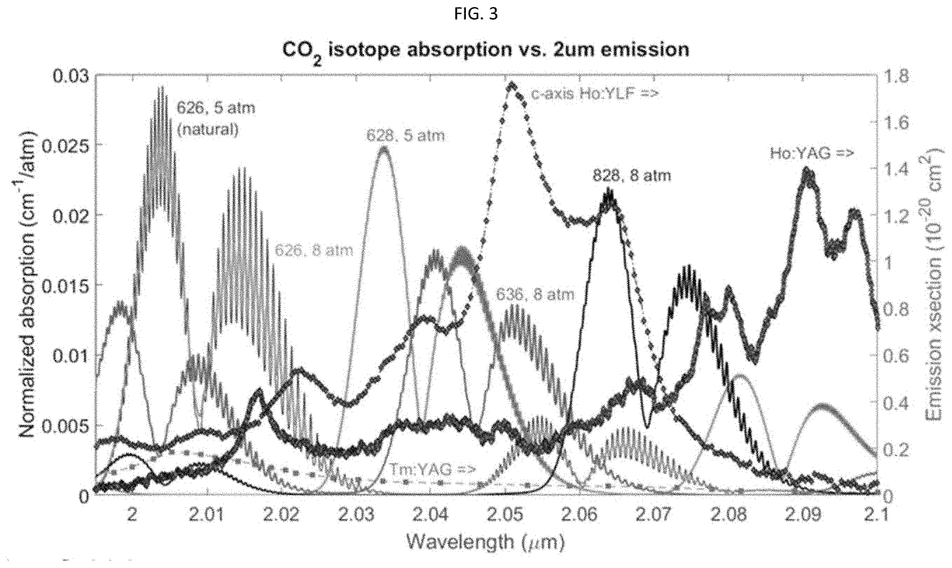

Referring to FIG. 3, the CO₂ isotope absorption versus 2 μm emission spectrum, by virtue of emission cross section, according to the principles of the present disclosure is shown. More specifically, the resultant pressure broadened absorption bands of the identified CO₂ molecular isotopologues are presented. This is just a sample of stable CO₂ molecular isotopologues, not all available molecular isotopologues are shown. Overlayed are the emission cross sections of Ho and Tm. Where these each peak is indicative of which molecular isotopologues of CO₂ they are best spectrally matched to.

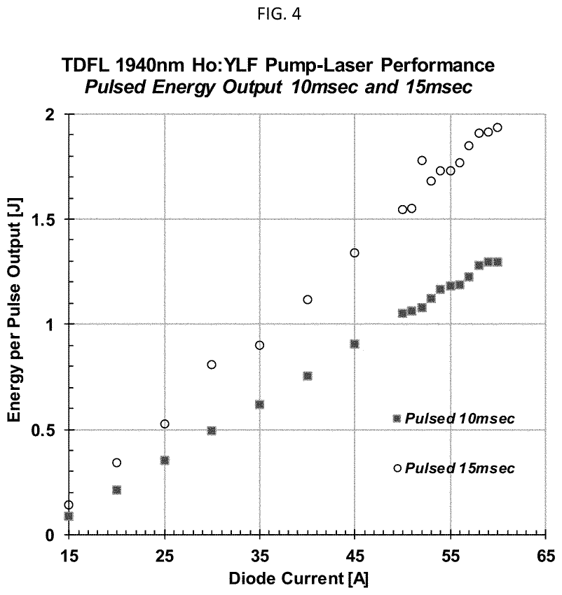

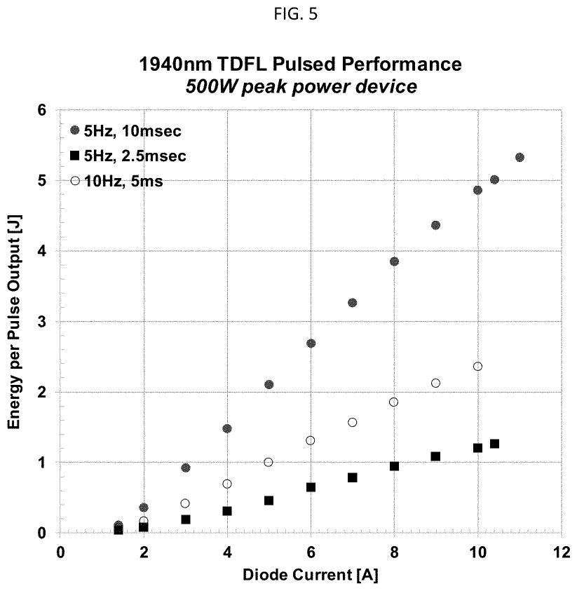

Referring to FIG. 4, a plot of energy per pulse versus diode current for one embodiment of a scalable optically pumped CO₂ laser with a Holmium-doped pump source according to the principles of the present disclosure is shown. More specifically, in this embodiment, a Ho:YLF laser is pumped by a Tm fiber laser (TDFL) at 1940 nm for 10 ms and 15 ms durations. The plot shows that the output energy per pulse is about 1.3 J at 10 ms and about 2 J at 15 ms for the same diode current. Specifically, the operating distinction between the two cases is the TDFL pump pulse duration applied to the Ho:YLF. In certain embodiments, the longer the diode is pumped, the energy output for that event scales linearly. Therefore, the TDFL output scales linearly (quasi continuous wave). Thus, the energy investiture in the Ho increases linearly, and results in ˜(15/10)*1.3˜2 J for the longer event.

Referring to FIG. 5, a plot of energy per pulse versus diode current for another embodiment of a scalable optically pumped CO₂ laser with a Holmium-doped pump source according to the principles of the present disclosure is shown. More specifically, in this embodiment, the behavior of the TDFL 1940 nm pump for the Ho:YLF laser is recorded. Here, energy scaling of the TDFL component is demonstrated. The TDFL is laser diode pumped at 2.5 ms and 10 ms at 5 Hz, and 5 ms at 10 Hz. The plot shows that the output energy per pulse is about 1.3 J at 2.5 ms at 5 Hz; about 2.3 J at 10 ms at 5 Hz; and about 5.5 J at 10 ms at 5 Hz. Thus, demonstrating that the increment in output energy between 2.5 ms and 10 ms is approximately linear in terms of diode laser pump pulse duration for a common drive current, and that at for about 2.5 ms the TDFL is comfortably in excess of threshold.

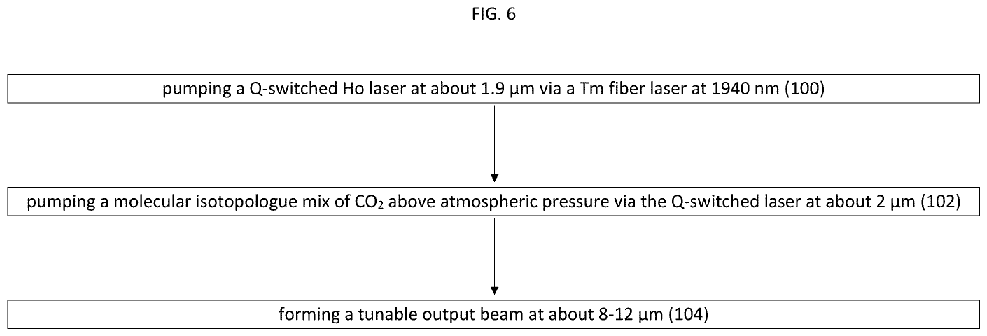

Referring to FIG. 6, a flowchart of a method for optically pumping a CO₂ laser is shown. More specifically, a Q-switched Ho laser is pumped at about 1.9 μm via a Tm fiber laser at 1940 nm (100). A molecular isotopologue mix of CO₂ is then pumped at above atmospheric pressure via the Q-switched Ho laser at about 2 μm (102). A tunable output beam at about 8-12 μm is formed.

In some cases, commercial applications could include industrial and material processing. In other cases, real standoff remote sensing of chemical weapon agents within the molecular fingerprint region is possible, as are numerous military/security applications. The system and method of the present disclosure enables new material processing capabilities while potentially maintaining compatibility with existing equipment. For example, laser driven extreme ultraviolet (EUV) sources for semiconductor lithography. Currently these systems utilize low pressure RF driven CO₂ lasers. These are optimally continuous wave (CW) devices, not pulsed, but in this particular application need to be pulsed. Current systems are massive given the very low volumetric extractions possible (approximately 3 orders of magnitude smaller than possible via the OP-CO₂ route of this proposal). Additionally, these systems are typically run as Master Oscillator Power Amplifiers (MOPA), creating power scaling issues since it is possible to run into amplified spontaneous emissions (ASE) or parasitic instability issues.

In certain other embodiments, the Holmium-based pump source is used to drive variously more complex gas mixtures than just pure CO₂ isotopes, including standard buffer gases (N, He, Ne, Ar) and an optical excitation catalysts such as HBr for increased efficiency.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the disclosure. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. An optically pumped CO₂ laser, comprising:
a Thulium (Tm) doped fiber laser configured to pump a Q-switched Holmium (Ho) laser at about 1.9 μm;
the Q-switched Ho laser being configured to pump a molecular isotopologue mix of CO₂ above atmospheric pressure at about 2 μm, to produce a tunable output beam at about 8-12 μm.

2. The optically pumped CO₂ laser according to claim 1, wherein the tunable output beam has a sub picosecond to 10s of nanosecond pulsed regime capability.

3. The optically pumped CO₂ laser according to claim 1, wherein the tunable output beam is pulsed mJ to J class or greater.

4. The optically pumped CO₂ laser according to claim 1, wherein the atmospheric pressure is in a range of 2.5 atm to 10 atm.

5. The optically pumped CO₂ laser according to claim 1, wherein the molecular isotopologue mix of CO₂ is arbitrary in both proportion and species.

6. The optically pumped CO₂ laser according to claim 1, wherein the molecular isotopologue mix of CO₂ comprises symmetric molecular isotopologues as component species of an active gas mix.

7. The optically pumped CO₂ laser according to claim 1, wherein the molecular isotopologue mix of CO₂ comprises symmetric and asymmetric molecular isotopologues as component species of an active gas mix.

8. The optically pumped CO₂ laser according to claim 1, wherein the Tm fiber laser is at 1940 nm and pumps the Q-switched Ho laser for pulse durations in a range of about 2 ms to about 15 ms.

9. The optically pumped CO₂ laser according to claim 1, wherein the Tm fiber laser pumps the Q-switched Ho laser via continuous wave.

10. The optically pumped CO₂ laser according to claim 1, wherein the Ho laser is in a spectral range of about 2.05 μm to about 2.1 μm.

11. An optically pumped CO₂ laser, comprising:
a Tm fiber laser at 1940 nm configured to pump a Q-switched Ho laser at about 1.9 μm;
the Q-switched Ho laser being configured to pump a molecular isotopologue mix of CO₂ at an atmospheric pressure ranging from about 2.5 atm to about 10 atm at about 2 μm, to produce a tunable output beam at about 8-12 μm.

12. The optically pumped CO₂ laser according to claim 11, wherein the tunable output beam has a sub picosecond to 10s of nanosecond pulsed regime capability.

13. The optically pumped CO₂ laser according to claim 11, wherein the tunable output beam is pulsed at mJ to J class or greater.

14. The optically pumped CO₂ laser according to claim 11, wherein the molecular isotopologue mix of CO₂ comprises symmetric molecular isotopologues as component species of an active gas mix.

15. A method for optically pumping a CO₂ laser, comprising:
pumping a Q-switched Ho laser at about 1.9 μm via a Tm fiber laser at 1940 nm;
pumping a molecular isotopologue mix of CO₂ at above atmospheric pressure via the Q-switched Ho laser at about 2 μm; and
forming a tunable output beam at about 8-12 μm.

16. The method for optically pumping a CO₂ laser according to claim 15, wherein the tunable output beam is pulsed at mJ to J class or greater.

17. The method for optically pumping a CO₂ laser according to claim 15, wherein the molecular isotopologue mix of CO₂ is arbitrary in both proportion and species.

18. The method for optically pumping a CO₂ laser according to claim 15, wherein an operating atmospheric pressure ranges from about 2.5 atm to about 10 atm.

19. The method for optically pumping a CO₂ laser according to claim 15, wherein the tunable output beam has a sub picosecond to 10s of nanosecond pulsed regime capability.

20. The method for optically pumping a CO₂ laser according to claim 15, wherein the molecular isotopologue mix of CO₂ comprises symmetric molecular isotopologues as component species of an active gas mix.
